(19) United States
(12) Patent Application Publication
(10) Pub. No.: US 2021/0380819 A1
(43) Pub. Date: Dec. 9, 2021

(54) VINYL-MODIFIED FLUOROCARBON RESIN AND PREPARATION METHOD THEREOF, AND CORROSION RESISTANT COATING AND PREPARATION METHOD AND USE THEREOF

(71) Applicant: Chengdu Hongrun Paint Co.,Ltd., Sichuan (CN)

(72) Inventors: Yong Jiang, Sichuan (CN); Ruliang Yang, Sichuan (CN); Fei Yang, Sichuan (CN); Di Yin, Sichuan (CN); Hebing Jiang, Sichuan (CN); Lin Xiong, Sichuan (CN); Yuan Yue, Sichuan (CN); Guangcai Yan, Sichuan (CN)

(21) Appl. No.: 16/993,735

(22) Filed: Aug. 14, 2020

(30) Foreign Application Priority Data
Jun. 4, 2020 (CN) 202010499588.5

(51) Int. Cl. C09D 5/08; C08G 18/67; C09D 175/16; C09D 7/20; C09D 7/61; C09D 7/40

(52) U.S. Cl. CPC C09D 5/084; C08G 18/6705; C09D 7/67; C09D 7/20; C09D 7/61; C09D 175/16

(57) ABSTRACT

A method for preparing a vinyl-modified fluorocarbon resin comprises mixing a fluorine-containing vinyl monomer, an initiator, and a tetrafluoroethylene monomer in a gas phase to carry out an addition reaction so as to obtain the vinyl-modified fluorocarbon resin. The fluorine-containing vinyl monomer is grafted onto tetrafluoroethylene, resulting in a vinyl-modified fluorocarbon resin which is highly resistant to strong acids and bases as well as weathering. The corrosion resistant coating prepared by using the resin as a base resin also has high resistances to strong acids and bases as well as weathering.

### TECHNICAL FIELD

The present disclosure relates to the field of protective coatings, and in particular to a vinyl-modified fluorocarbon resin and a preparation method thereof, as well as a corrosion resistant coating and a preparation method and use thereof.

### BACKGROUND

Many fields, such as petroleum, petrochemicals, chemical synthesis, wastewater treatment and chemical agent transport vehicles, can involve harsh environments having different pH levels. At a pH of 3 or less, it is a strongly acidic environment, and at a pH of 11 or more, it is a strongly basic environment. Such a strongly acidic or basic environment requires an extremely high chemical resistance of coatings so as to enable protection of metal surfaces.

Conventional protective coatings for metals include solventless epoxy, fluorocarbon resin, chlorinated rubber, perchlorovinyl, high chlorinated polyethylene, chloro-sulfonated polyethylene, phenolic epoxy, and Novolac® vinyl ester resin coatings and asphalt. However, the solventless epoxy, phenolic epoxy, and Novolac® vinyl ester resin coatings and asphalt are poor in weathering resistance; and the fluorocarbon resin, chlorinated rubber, perchlorovinyl, high chlorinated polyethylene, and chloro-sulfonated polyethylene coatings are suitable only for the environments having pH values within the range of 3 to 11, and are poor in corrosion resistance in a strongly acidic or basic environment.

Thus, a corrosion resistant coating which can be resistant to strong acids and bases as well as weathering is desired.

### SUMMARY

An objective of the present disclosure is to provide a method for preparing a vinyl-modified fluorocarbon resin which enables a coating that is highly resistant to strong acids and bases as well as weathering.

The above objective of the present disclosure is realized by a method for preparing a vinyl-modified fluorocarbon resin, comprising: mixing a fluorine-containing vinyl monomer, an initiator, and a tetrafluoroethylene monomer in a gas phase to carry out an addition reaction so as to obtain the vinyl-modified fluorocarbon resin.

Preferably, the addition reaction is carried out at a temperature of 75 to 80° C. for 18 to 22 hours.

Another objective of the present disclosure is to provide a vinyl-modified fluorocarbon resin prepared by the method as described above.

Yet another objective of the present disclosure is to provide a corrosion resistant coating, comprising a component A and a component B packaged separately;

wherein the component A comprises 50 to 70 parts by weight of the vinyl-modified fluorocarbon resin as described above, 3 to 8 parts by weight of a filler, 2 to 5 parts by weight of zinc phosphate, 2 to 5 parts by weight of a graphene dispersion, 5 to 20 parts by weight of a pigment, 0.2 to 1 parts by weight of a dispersant, 0.1 to 0.3 parts by weight of a defoaming agent, 0.1 to 0.3 parts by weight of a leveling agent, 1 to 3 parts by weight of a polyamide wax dispersion, 0.2 to 0.5 parts by weight of fumed silica, and 9 to 16 parts by weight of an organic solvent; wherein, the graphene dispersion has a solid content of 2 to 10% by weight, and the polyamide wax dispersion has a solid content of 10 to 20% by weight;
wherein the component B is an isocyanate;
and wherein, the components A and B are adapted to be mixed in use in a weight ratio of 100:10-30.

Preferably, the filter is nanoscale barium sulphate having a particle size of 5 to 10 nanometers.

Preferably, the organic solvent comprises an aromatic solvent, an ester solvent, a hydrocarbon solvent, a ketone solvent, and an ether solvent in a ratio by volume of 3-4:3-4:1-2:1-2:1-2.

A further objective of the present disclosure is to provide a method for preparing the corrosion resistant coating as described above, comprising:

a step of preparing the component A, which comprises:
(1) performing a first mixing to mix the vinyl-modified fluorocarbon resin, the dispersant, the defoaming agent, the polyamide wax dispersion and a portion of the organic solvent so as to obtain a first slurry;
(2) performing a second mixing to mix the first slurry, the pigment, zinc phosphate, the filler, and the fumed silica so as to obtain a second slurry;
(3) performing a third mixing to mix the second slurry and the graphene dispersion so as to obtain a third slurry; and
(4) performing a fourth mixing to mix the third slurry, the leveling agent, and a remainder of the organic solvent so as to obtain the component A;
   and, mixing the component A with the component B when in use.

Preferably, the portion of the organic solvent is 50 to 70% by weight of a total weight of the organic solvent.

Preferably, the first mixing is performed under first stirring conditions of a stirring speed of 600 to 800 rpm and a stirring time of 3 to 5 minutes.

Preferably, the second mixing comprises successively: a second stirring step carried out with a stirring speed of 800 to 1000 rpm for 15 to 20 minutes, and a grinding step. The third slurry may have a fineness of 20 to 30 microns.

Preferably, the third mixing is performed under third stirring conditions of a stirring speed of 1000 to 1200 rpm and a stirring time of 15 to 20 minutes.

Preferably, the fourth mixing is performed under fourth stirring conditions of a stirring speed of 800 to 1000 rpm and a stirring time of 5 to 10 minutes.

Yet a further objective of the present disclosure is to provide use of the corrosion resistant coating as described above or of the corrosion resistant coating prepared according to the method as described above in protection of a metal surface.

One aspect of the present disclosure provides a method for preparing a vinyl-modified fluorocarbon resin, comprising: mixing a fluorine-containing vinyl monomer, an initiator, and a tetrafluoroethylene monomer in a gas phase to carry out an addition reaction so as to obtain the vinyl-modified fluorocarbon resin. According to this disclosed method, the fluorine-containing vinyl monomer is grafted onto tetrafluoroethylene so that the vinyl-modified fluorocarbon resin obtained can exhibit excellent resistances to strong acids and bases as well as weathering.

Another aspect of the present disclosure provides a corrosion resistant coating, comprising a component A and a component B packaged separately; wherein the component A comprises 50 to 70 parts by weight of the vinyl-modified fluorocarbon resin, 3 to 8 parts by weight of a filler, 2 to 5 parts by weight of zinc phosphate, 2 to 5 parts by weight of a graphene dispersion, 5 to 20 parts by weight of a pigment, 0.2 to 1 parts by weight of a dispersant, 0.1 to 0.3 parts by weight of a defoaming agent, 0.1 to 0.3 parts by weight of a leveling agent, 1 to 3 parts by weight of a polyamide wax dispersion, 0.2 to 0.5 parts by weight of fumed silica, and 9 to 16 parts by weight of an organic solvent; wherein, the graphene dispersion may have a solid content of 10% by weight, and the polyamide wax dispersion may have a solid content of 20% by weight; wherein the component B is an isocyanate; and wherein the components A and B are adapted to be mixed in use in a weight ratio of 100:10-30. According to this aspect, the corrosion resistant coating is obtained from the vinyl-modified fluorocarbon resin serving as a base resin and an isocyanate serving as a curing agent as well as other ingredients. The corrosion resistant coating can enable a coating film formed by applying the coating to be resistant to strong acids and bases as well as weathering. Moreover, when applied, the corrosion resistant coating can dry quickly, and exhibit good leveling, and there occurs no foaming of a thick coating film formed. In addition, the coating film formed can have a high hardness, high resistances to abrasion and water, and a high gloss appearance. The disclosed coating can be suitable for use in many fields, such as petroleum and petrochemical, acid and alkaline factories, chemical synthesis workshops, chemical agent transport vehicles, and wastewater treatment. Results of examples of the present disclosure have shown that, when applied, the corrosion resistant coating can dry quickly, and have a high adhesion and a good workability. The results have also shown that the coating can be resistant to 5 to 70% acids (HF, HCl, H₂SO₄, HNO₃, H₃PO₄, H₂C₂O₄) at 60° C., and there occurs no foaming after being immersed therein for 30 days; and that the coating can be resistant to 5 to 70% bases (NaOH, Ca(OH)₂, Ba(OH)₂, Cu(OH)₂) at 60° C., and there occurs no foaming and it exhibits high gloss and high weathering resistance after being immersed therein for 30 days.

### BRIEF DESCRIPTION OF THE DRAWINGS

FIG. 1 shows a structural formula of the fluorine-containing vinyl monomer;

FIG. 2 shows a molecular structure of and actions of different segments of the vinyl-modified fluorocarbon resin according to the present disclosure; and

FIG. 3 shows a scheme for the synthesis of the vinyl-modified fluorocarbon resin according to the present disclosure.

### DETAILED DESCRIPTION

One aspect of the present disclosure provides a method for preparing a vinyl-modified fluorocarbon resin, comprising: mixing a fluorine-containing vinyl monomer, an initiator, and a tetrafluoroethylene monomer in a gas phase to carry out an addition reaction so as to obtain the vinyl-modified fluorocarbon resin.

The method for preparing the perfluoro group-containing vinyl monomer is not particularly limited, and any preparation method therefor well known to those skilled in the art may be used. In an embodiment, the method for preparing the perfluoro group-containing vinyl monomer comprises steps of:

(1) mixing perfluorooctanoic acid, thionyl chloride and N,N-dimethylformamide to carry out a first esterification reaction so as to obtain perfluorooctanoyl fluoride;
(2) mixing the perfluorooctanoyl fluoride obtained in step (1), ethanolamine and tetrahydrofuran (THF) to carry out a second esterification reaction so as to obtain N-hydroxyethyl perfluorooctamide;
(3) mixing the N-hydroxyethyl perfluorooctamide obtained in step (2), 2,4-toluene diisocyanate (TDI), methyl isobutyl ketone (MIBK), dibutyltin dilaurate, and 2-hydroxyethyl methacrylate to carry out an addition reaction so as to obtain the fluorine-containing vinyl monomer.

In this embodiment, perfluorooctanoic acid, thionyl chloride and N,N-dimethylformamide are first mixed together to carry out a first esterification reaction so as to obtain perfluorooctanoyl fluoride. The weight ratio of perfluorooctanoic acid/thionyl chloride/N,N-dimethylformamide is preferably 15:9:3-5, more preferably 15:9:3. The first esterification reaction may be carried out at a temperature preferably in the range of 70 to 100° C., more preferably at 85° C., for a duration preferably in the range of 50 to 70 minutes, more preferably for 1 hour. Preferably, the method further comprises: after completion of the first esterification reaction, subjecting the resulting reaction mixture to distillation under reduced pressure to remove excess thionyl chloride and to collect a fraction boiling at 60 to 72° C. under 1.07 kPa so as to obtain perfluorooctanoyl fluoride as a white clear liquid having a pungent odor with a yield of greater than 92%.

In the above embodiment, after perfluorooctanoyl fluoride is obtained, it is mixed with ethanolamine and THF to carry out a second esterification reaction so as to obtain N-hydroxyethyl perfluorooctamide. Preferably, the ratio of perfluorooctanoyl fluoride/ethanolamine/THF is 8-10 g:2-3 g:9-12 mL, more preferably 8.5 g:2.5 g:10 mL. In some embodiments, ethanolamine is first mixed with THF and cooled with an ice-salt bath to a temperature of 5° C. or lower, and perfluorooctanoyl fluoride is then slowly added dropwise thereto under stirring.

The second esterification reaction may be carried out at a temperature preferably in the range of 30 to 40° C., more preferably at 30° C., for a duration preferably in the range of 2 to 4 hours, more preferably for 3 hours. Preferably, the method further comprises: after completion of the second esterification reaction, subjecting the resulting reaction mixture to distillation under reduced pressure to remove THF, and then to be washed with 10 mL of hot water (70° C.) and, whilst hot, subjected to liquid separation; and subjecting a creamy mass resulting therefrom to pH adjustment to bring the pH thereof to 7.5 to 8.0 by using dilute hydrochloric acid, to be washed once with hot water and then to be recrystallized 2 times from chloroform to obtain N-hydroxyethyl perfluorooctamide as a light yellow crystal with a yield of greater than 77% and a melting point of 51 to 52° C.

In the above embodiment, after N-hydroxyethyl perfluorooctamide is obtained, it is mixed with TDI, MIBK and dibutyltin dilaurate to carry out an addition reaction so as to obtain the perfluoro group-containing vinyl monomer. The ratio of N-hydroxyethyl perfluorooctamide/TDI/MIBK/2-hydroxyethyl methacrylate is preferably 4.2-4.8 g:1.5-1.8 g:3-6 mL:1.1-1.9 g, more preferably 4.57 g:1.74 g:4 mL:1.6 g. In some embodiments, TDI, MIBK and one drop of dibutyltin dilaurate are first mixed and warmed to 65 to 70° C. under a nitrogen atmosphere, and 4.57 g of N-hydroxyethyl perfluorooctamide and then 12 mL of anhydrous MIBK are slowly added dropwise thereto during 1 hour. Thereafter, these ingredients are reacted at that temperature for 3 hours followed by addition of two drops of dibutyltin dilaurate and then, after being warmed to 75 to 80° C., addition of 1.6 g of 2-hydroxyethyl methacrylate.

The addition reaction may be carried out at a temperature preferably in the range of 75 to 80° C., more preferably at 75° C., for a duration preferably in the range of 3 to 6 hours, more preferably for 4 hours. Preferably, the method further comprises: after completion of the addition reaction, subjecting the resulting reaction mixture to distillation under reduced pressure to remove MIBK and then to recrystallization from THF to obtain the perfluoro group-containing vinyl monomer as a light brown, transparent crystal with a yield of greater than 81%.

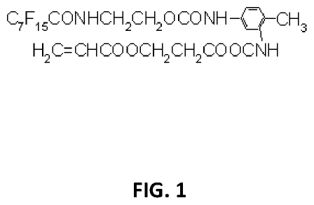

A structural formula of the fluorine-containing vinyl monomer is shown in FIG. 1.

The initiator is preferably maleic anhydride (MA).

The structural formula of the tetrafluoroethylene monomer in a gas phase is C₂F₄.

The weight ratio of the fluorine-containing vinyl monomer/the initiator/the tetrafluoroethylene monomer is preferably 15:9:3.

In an embodiment, the fluorine-containing vinyl monomer is first mixed with the initiator to form a mixed liquid, and nitrogen containing the tetrafluoroethylene monomer in a gas phase is then introduced into the mixed liquid. In some embodiments, a useful level of tetrafluoroethylene in the tetrafluoroethylene monomer in a gas phase is less than 2×10⁻⁵ g/L.

The addition reaction is preferably carried out under stirring, and a preferable speed of the stirring is 2000 to 2500 rpm. In addition, the addition reaction may be carried out at a temperature preferably in the range of 75 to 80° C., more preferably at 76° C., for a duration preferably in the range of 18 to 22 hours, more preferably for 20 hours. During the addition reaction, the fluorine-containing vinyl monomer is grafted onto the tetrafluoroethylene monomer.

Preferably, the method for preparing a vinyl-modified fluorocarbon resin according to the present disclosure further comprises: after completion of the addition reaction, cooling a reactor in which the addition reaction is conducted, along with the resulting reaction mixture therein; and introducing nitrogen into the reactor after vacuuming to substitute for the atmosphere, so as to obtain the vinyl-modified fluorocarbon resin. The cooling is preferably conducted at a rate of 1° C./min, and the reaction mixture is preferably cooled to 25° C. The nitrogen is used to prevent production of by-products.

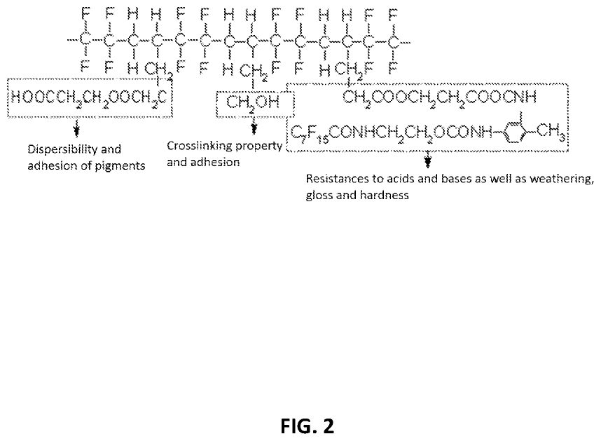

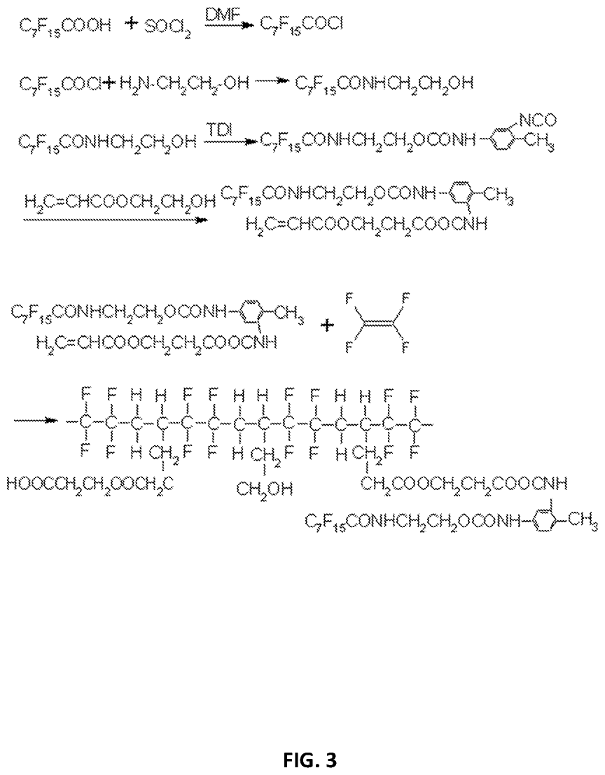

The vinyl-modified fluorocarbon resin prepared by the method according to the disclosure has a molecular structure as shown in FIG. 2, and a scheme for the synthesis thereof is shown in FIG. 3. The vinyl-modified fluorocarbon resin contains a hydroxyl group, a carboxyl group and a side chain containing a fluorine atom. The hydroxyl group can improve crosslinking property and adhesion of the resin. The carboxyl group can improve the adhesion of a pigment to the resin. The side chain containing a fluorine atom can enable improved resistances to weathering, acids and bases, and a higher hardness and gloss level, of a coating film formed by applying a coating prepared from the resin.

As can be seen from FIG. 2, in preparation of a corrosion resistant coating when using the disclosed vinyl-modified fluorocarbon resin, groups contained therein can enable an improved dispersibility and adhesion of a pigment and can facilitate crosslinking of ingredients. In addition, these groups can increase flexibility and solubility of the resin, and can enable improved transparency, gloss, hardness and resistance to weathering of a coating film formed by applying the coating.

Another aspect of the present disclosure provides a corrosion resistant coating, comprising a component A and a component B packaged separately; wherein the component A comprises 50 to 70 parts by weight of the vinyl-modified fluorocarbon resin, 3 to 8 parts by weight of a filler, 2 to 5 parts by weight of zinc phosphate, 2 to 5 parts by weight of a graphene dispersion, 5 to 20 parts by weight of a pigment, 0.2 to 1 parts by weight of a dispersant, 0.1 to 0.3 parts by weight of a defoaming agent, 0.1 to 0.3 parts by weight of a leveling agent, 1 to 3 parts by weight of a polyamide wax dispersion, 0.2 to 0.5 parts by weight of fumed silica, and 9 to 16 parts by weight of an organic solvent; wherein, the graphene dispersion has a solid content of 2 to 10% by weight, and the polyamide wax dispersion has a solid content of 10 to 20% by weight; wherein the component B is an isocyanate; and wherein the components A and B are adapted to be mixed in use in a weight ratio of 100:10-30, preferably 100:20.

The component A comprises 50 to 70 parts by weight of the vinyl-modified fluorocarbon resin, preferably 50, 60, or 70 parts by weight of the vinyl-modified fluorocarbon resin. The preparation method and structural formula of the vinyl-modified fluorocarbon resin refer to the above-mentioned description and are not described here. The vinyl-modified fluorocarbon resin can be highly resistant to strong acids and bases as well as weathering, and can thus enable improved resistances to acids and bases, of the coating.

The component A further comprises 3 to 8 parts by weight of a filler, preferably 3, 4 or 8 parts by weight of a filler, based upon the weight parts of the vinyl-modified fluorocarbon resin. Preferably, the filter is nanoscale barium sulphate having a particle size of 5 to 10 nanometers, more preferably 5 nanometers. In a particular embodiment, the nanoscale barium sulphate is obtained from Changhe Group. The nanoscale barium sulphate can be highly chemically inert and resistant to acids and bases, exhibit a good stability, a moderate hardness, a high specific gravity and a high whiteness, and adsorb harmful rays. Thus, the use thereof can enables improved resistances to strong acids and bases of the corrosion resistant coating.

The component A further comprises 2 to 5 parts by weight of zinc phosphate, preferably 2, 3, or 5 parts by weight of zinc phosphate, based upon the weight parts of the vinyl-modified fluorocarbon resin. In an embodiment, zinc phosphate is zinc phosphate PZ20 obtained from Worldwide Resin & Chem. The use of zinc phosphate can enable an improved salt spray resistance of the coating film.

The component A further comprises 2 to 5 parts by weight of a graphene dispersion, preferably 2, 3, or 5 parts by weight of a graphene dispersion, based upon the weight parts of the vinyl-modified fluorocarbon resin, and the graphene dispersion has a solid content of 2 to 10% by weight, preferably 10% by weight. In an embodiment, the graphene dispersion is obtained from Graphene-Tech. The use of the graphene dispersion can enable an improved chemical resistance and an improved slat spray resistance of the coating film.

The component A further comprises 5 to 20 parts by weight of a pigment, preferably 5, 11, or 20 parts by weight of a pigment, based upon the weight parts of the vinyl-modified fluorocarbon resin. The pigment is preferably an inorganic pigment, more preferably rutile titanium dioxide or iron oxide black. In an embodiment, the pigment is obtained from Hangzhou Synox Pigments Co., Ltd. The use of the pigment can enable an improved aesthetic appearance and media resistance of the coating film.

The component A further comprises 0.2 to 1 parts by weight of a dispersant, preferably 0.2 or 0.5 parts or 1 part by weight of a dispersant, based upon the weight parts of the vinyl-modified fluorocarbon resin. The dispersant preferably comprises a high molecular weight block copolymer as an effective ingredient, and the dispersant is preferably BYK163. The use of the dispersant can facilitate dispersion of the pigment and the filler in the system to prevent coagulation and precipitation thereof.

The component A further comprises 0.1 to 0.3 parts by weight of a defoaming agent, preferably 0.1, 0.2, or 0.3 parts by weight of a defoaming agent, based upon the weight parts of the vinyl-modified fluorocarbon resin. The defoaming agent preferably comprises modified polyorganosiloxane as an effective ingredient, and the defoaming agent is preferably Defom 5800F from ELEMENTIS. The use of the defoaming agent can prevent foaming of the coating film.

The component A further comprises 0.1 to 0.3 parts by weight of a leveling agent, preferably 0.1, 0.2, or 0.3 parts by weight of a leveling agent, based upon the weight parts of the vinyl-modified fluorocarbon resin. The leveling agent preferably comprises modified polyorganosiloxane as an effective ingredient, and the leveling agent is preferably Levaslip 466 obtained from Shanghai Right Base Chemicals Co., Ltd. The use of the leveling agent can facilitate levelling of the coating, when being applied, and thus enable an improved levelness of the coating film.

The component A further comprises 1 to 3 parts by weight of a polyamide wax dispersion, preferably 1, 2, or 3 parts by weight of a polyamide wax dispersion, based upon the weight parts of the vinyl-modified fluorocarbon resin. In an embodiment, the polyamide wax dispersion is DISPARLON 6900-20. The polyamide wax dispersion has a solid content of 10 to 20% by weight, preferably 20%. The use of the polyamide wax dispersion can enable an improved anti-precipitation property and an improved sag resistance of the corrosion resistant coating.

The component A further comprises 0.2 to 0.5 parts by weight of fumed silica, preferably 0.2, 0.3, or 0.5 parts by weight of fumed silica, based upon the weight parts of the vinyl-modified fluorocarbon resin. In an embodiment, the fumed silica is HDK® N20 obtained from Shanghai Haiyi Scientific & trading. The use of the fumed silica can enable an improved anti-precipitation property of the coating.

The component A further comprises 9 to 16 parts by weight of an organic solvent, preferably 9.2, 9.7, or 15.2 parts by weight of an organic solvent, based upon the weight parts of the vinyl-modified fluorocarbon resin. In an embodiment, the organic solvent includes a mixture of an aromatic solvent, an ester solvent, a hydrocarbon solvent, a ketone solvent, and an ether solvent preferably in a ratio by volume of 3-4:3-4:1-2:1-2:1-2, more preferably in a ratio by volume of 3:4:1:1:1. As the aromatic solvent, xylene is particularly preferably used. As the ester solvent, anhydrous butyl acetate is particularly preferably used. As the hydrocarbon solvent, hexane is particularly preferably used. As the ketone solvent, methyl isobutyl ketone is particularly preferably used. As the ether solvent, ethylene glycol monobutyl ether is particularly preferably used. This mixed solvent can be used for diluting the other ingredients of the coating and improving the uniformity thereof.

The component B is an isocyanate, and preferably Basonat® HI 100. The isocyanate is used as a curing agent and undergoes a crosslinking reaction with the vinyl-modified fluorocarbon resin of the component A, which leads to the curing of the reaction mixture and thus enables an increased drying speed of the coating when being applied.

A third aspect of the present disclosure provides a method for preparing the corrosion resistant coating as described above, comprising a step of preparing the component A which comprises:

(1) performing a first mixing to mix the vinyl-modified fluorocarbon resin, the dispersant, the defoaming agent, the polyamide wax dispersion and a portion of the organic solvent so as to obtain a first slurry;
(2) performing a second mixing to mix the first slurry, the pigment, zinc phosphate, the filler, and the fumed silica so as to obtain a second slurry;
(3) performing a third mixing to mix the second slurry and the graphene dispersion so as to obtain a third slurry; and
(4) performing a fourth mixing to mix the third slurry, the leveling agent, and a remainder of the organic solvent so as to obtain the component A.

According to this method, the vinyl-modified fluorocarbon resin, the dispersant, the defoaming agent, the polyamide wax dispersion and a portion of the organic solvent are first mixed to perform a first mixing so as to obtain a first slurry. The portion of the organic solvent is preferably 50 to 70% by weight, more preferably 60% by weight of a total weight of the organic solvent. The first mixing is preferably performed under first stirring conditions of a stirring speed of 600 to 800 rpm, particularly preferably 600 rpm and a stirring time of 3 to 5 minutes, particularly preferably 4 minutes.

After the first slurry is obtained, it is mixed with the pigment, zinc phosphate, the filler, and the fumed silica to perform a second mixing so as to obtain a second slurry. The second mixing preferably comprises successively: a second stirring step carried out with a stirring speed of 800 to 1000 rpm, particularly preferably 800 rpm for 15 to 20 minutes, particularly preferably 15 minutes, and a grinding step. The manner of the grinding is not particularly limited, and any suitable grinding manner may be used, proving that the second slurry obtained satisfies the required fineness. The fineness of the second slurry is preferably 20 to 30 microns, more preferably 20 microns. The grinding step can enable an improved levelness of the coating film.

After the second slurry is obtained, it is mixed with the graphene dispersion to perform a third mixing so as to obtain a third slurry. The third mixing is preferably performed under third stirring conditions of a stirring speed of 1000 to 1200 rpm, particularly preferably 1000 rpm and a stirring time of 15 to 20 minutes, particularly preferably 15 minutes.

After the third slurry is obtained, it is mixed with the leveling agent and a remainder of the organic solvent to perform a fourth mixing so as to obtain the component A. The fourth mixing is preferably performed under fourth stirring conditions of a stirring speed of 800 to 1000 rpm, particularly preferably 800 rpm and a stirring time of 5 to 10 minutes, particularly preferably 5 minutes.

According to the method, in order to prepare the component A, the mixing of the ingredients thereof is realized stepwise, which enables the ingredients to be uniformly dispersed in the system so that more excellent properties can be realized.

The components A and B are preferably provided separately and adapted to be mixed in use to obtain the corrosion resistant coating, and the mixing is preferably carried out under stirring at a stirring speed of 200 rpm for 5 minutes.

A fourth aspect of the present disclosure provides use of the corrosion resistant coating as described above or of the corrosion resistant coating prepared according to the method as described above in protection of a metal surface, preferably a surface of a petroleum or petrochemical pipeline, a chemical transport vehicle, a steel structure of a chemical plant, a chemical equipment, a gas holder, a mechanical equipment in a coal mine, an oceanographic ship, or a warship. The coating is preferably applied by the use of spray coating or roller coating, and when the spray coating is used, the amount of the coating sprayed is preferably 3.5 to 4 kg/m².

Particular examples of the present disclosure are described below for the purpose of setting forth the disclosure more clear and complete. Apparently, these examples are intended to describe only a part of embodiments of the present disclosure, and not all of embodiments thereof. All other embodiments obtained by those skilled in the art based on the embodiments of the present disclosure without creative efforts shall fall within the protection scope of the present disclosure.

### Example 1

Starting materials and manufactures or suppliers thereof:

Perfluorooctanoic acid, Shanghai 3F New Materials Co., Ltd.

Thionyl chloride, Nanjing Rundi Industrial Co., Ltd.

2-hydroxyethyl methacrylate, 2,4-toluene diisocyanate (TDI), methyl methacrylate, ethyl acrylate, and butyl acrylate; industrial grade; Sanmu Chemical Co., Ltd.

Ethanolamine, dibutyltin dilaurate, N,N-dimethylformamide, methyl isobutyl ketone (MIBK), chloroform, ethyl alcohol, acetone, NaOH, hexenoic acid monomer, and azobisisobutyronitrile; analytical reagent (AR); Chengdu Chron Chemicals Co., Ltd.

15 g of perfluorooctanoic acid and 9 g of thionyl chloride were introduced into a 4-necked flask fitted with a thermometer, a stirrer, and a reflux condensing tube, and 0.1 g of N,N-dimethylformamide serving as a catalyst was then added thereto to carry out an esterification reaction at 85° C. for 1 hour. The reaction end-point was checked by gas chromatographic analysis, and occurrence of a plateau value in the gas chromatogram was used as an indicator of the reaction end-point. Excess thionyl chloride was removed by distillation under reduced pressure, and a fraction boiling at 60 to 72° C. under 1.07 kPa was collected to obtain perfluorooctanoyl fluoride as a white clear liquid having a pungent odor with a yield of greater than 92%.

2.5 g of ethanolamine and 10 mL of THF were introduced into a four-necked flask, and then cooled with an ice-salt bath to a temperature of 5° C. or lower. 8.5 g of perfluorooctanoyl fluoride was slowly added dropwise thereto under stirring. After completion of the dropwise addition, the mixture was warmed to 30° C. to conduct an esterification reaction for 3 hours. A yellow creamy mass was thus obtained and gas chromatographic analysis showed that the reaction was complete. The yellow creamy mass was subjected to distillation under reduced pressure to remove THF, and was then washed with 10 mL of hot water (70° C.) and, whilst hot, subjected to liquid separation. Thereafter, the creamy mass so obtained was adjusted to pH 7.5 to 8.0 using dilute hydrochloric acid (0.1 g/mL), washed once with hot water and then recrystallized 2 times from chloroform to obtain N-hydroxyethyl perfluorooctamide as a light yellow crystal with a melting point of 51 to 52° C. and a yield of greater than 77%.

1.74 g of TDI, 4 mL of anhydrous MIBK, and one drop of dibutyltin dilaurate were introduced into a four-necked flask and sealed under dry nitrogen. The mixture was warmed to 66° C., and 4.57 g of N-hydroxyethyl perfluorooctamide and then 12 mL of anhydrous MIBK were slowly added dropwise thereto during 1 hour. After completion of the addition, the mixture was reacted at that temperature for 3 hours followed by addition of two drops of dibutyltin dilaurate and then, after being warmed to 79° C., addition of 1.6 g of 2-hydroxyethyl methacrylate to conduct an addition reaction for 4 hours at that temperature. At this time, gas chromatographic analysis showed that the reaction was complete. The resulting reaction mixture was subjected to distillation under reduced pressure to remove MIBK and then to recrystallization in THF to obtain fluorine-containing vinyl monomer as a light brown, transparent crystal with a yield of greater than 81%.

150 g of the fluorine-containing vinyl monomer and 90 g of an initiator were introduced into a reactor having stirring and electrical heating functions. The reactor was vacuumed until the oxygen level was reduced to less than 2×10⁻⁵ g/L. 30 g of tetrafluoroethylene monomer in a gas phase was then introduced into the reactor. The mixture in the reactor was warmed to 75° C. to conduct a reaction under stirring for 20 hours. After the reaction was complete, the system was cooled to 25° C. at a temperature decreasing rate of 1° C./min. Thereafter, the reactor was vacuumed, and nitrogen substituted for the atmosphere. The content of the reactor was discharged therefrom to obtain a vinyl-modified fluorocarbon resin.

### Example 2

A fluorine-containing vinyl monomer was prepared using the same method as in the preparation of Example 1.

300 g of the fluorine-containing vinyl monomer and 180 g of an initiator were introduced into a reactor having stirring and electrical heating functions. The reactor was vacuumed until the oxygen level was reduced to less than 2×10⁻⁵ g/L. 60 g of tetrafluoroethylene monomer in a gas phase was then introduced into the reactor. The mixture in the reactor was warmed to 76° C. to conduct a reaction under stirring for 20 hours. After the reaction was complete, the system was cooled to 25° C. at a temperature decreasing rate of 1° C./min. Thereafter, the reactor was vacuumed, and nitrogen substituted for the atmosphere. The content of the reactor was discharged therefrom to obtain a vinyl-modified fluorocarbon resin.

### Example 3

A fluorine-containing vinyl monomer was prepared using the same method as in the preparation of Example 1.

450 g of the fluorine-containing vinyl monomer and 270 g of an initiator were introduced into a reactor having stirring and electrical heating functions. The reactor was vacuumed until the oxygen level was reduced to less than 2×10⁻⁵ g/L. 90 g of tetrafluoroethylene monomer in a gas phase was then introduced into the reactor. The mixture in the reactor was warmed to 79° C. to conduct a reaction under stirring for 20 hours. After the reaction was complete, the system was cooled to 25° C. at a temperature decreasing rate of 1° C./min. Thereafter, the reactor was vacuumed, and nitrogen substituted for the atmosphere. The content of the reactor was discharged therefrom to obtain a vinyl-modified fluorocarbon resin.

### Examples 4-6

Starting materials and manufacturers or suppliers thereof:

Nanoscale barium sulphate, Changhegroup

Graphene dispersion, with a solid content of 10 wt. %, Graphene-Tech

Zinc phosphate, PZ20, Worldwide Resin & Chem

Inorganic pigment, Hangzhou Synox Pigments Co., Ltd.

Dispersant, BYK163, BYK

Defoaming agent, 5800F, ELEMENTIS

Leveling agent, Levaslip 466, Shanghai Right Base Chemicals Co., Ltd.

Polyamide wax dispersion, with a solid content of 10 to 20%, 6900-20, DISPARLON

Fumed silica, HDK® N20, Shanghai Haiyi Scientific & trading

Mixed organic solvent (an aromatic solvent (in particular toluene, xylene, or trimethylbenzene):an ester solvent (in particular ethyl ester, butyl ester, or dibutyl carbonate):a hydrocarbon solvent (in particular ethane, propane, or hexane):a ketone solvent (in particular butanone, or acetone):an ether solvent (in particular diethylene glycol monobutyl ether)=3:4:1:1:1)

Isocyanate (Isocyanate Type Curing Agent)

The vinyl-modified fluorocarbon resin prepared in Examples 1 to 3, the dispersant, the defoaming agent, the polyamide wax dispersion, and 60% by weight of the mixed organic solvent were mixed together under stirring with a speed of 600 rpm for 3 minutes to obtain a first slurry.

The first slurry was mixed with the inorganic pigment, zinc phosphate, nanoscale barium sulphate, and the fumed silica under stirring with a speed of 800 rpm for 15 minutes. The mixture was then ground to a fineness of 20 microns using a grinder to obtain a second slurry.

The second slurry was mixed with the graphene dispersion under stirring with a stirring speed of 1000 rpm for 15 minutes to obtain a third slurry.

The third slurry was mixed with the leveling agent and a remainder of the organic solvent under stirring with a stirring speed of 800 rpm for 5 minutes to obtain a component A.

Weight parts of the ingredients of the component A are listed in Table 1.

When in use, the component A was mixed with the isocyanate in a weight ratio of 100:20 under stirring with a stirring speed of 200 rpm for 5 minutes to obtain a corrosion resistant coating; wherein, in Example 4, the coating was prepared from the vinyl-modified fluorocarbon resin prepared in Example 1; in Example 5, the coating was prepared from the vinyl-modified fluorocarbon resin prepared in Example 2; and in Example 6, the coating was prepared from the vinyl-modified fluorocarbon resin prepared in Example 3.

TABLE 1
Weight parts of ingredients of the component A in Examples 4-6

| | Example | Example | Example |
|---|---|---|---|
| | 4 | 5 | 6 |
| Vinyl-modified fluorocarbon resin | 50 | 60 | 70 |
| Dispersant | 0.2 | 0.5 | 1 |
| Defoaming agent | 0.1 | 0.3 | 0.2 |
| Polyamide wax dispersion | 3 | 2 | 1 |
| Fumed silica | 0.2 | 0.3 | 0.5 |
| Inorganic pigment | 20 | 11 | 5 |
| Nanoscale barium sulphate | 3 | 4 | 8 |
| Zinc phosphate | 3 | 5 | 2 |
| Graphene dispersion | 5 | 3 | 2 |
| Leveling agent | 0.3 | 0.2 | 0.1 |
| Mixed solvent | 15.2 | 9.7 | 9.2 |
| Total | 100 | 100 | 100 |

### Comparative Example 1

A corrosion resistant coating was prepared according to the method as described in Example 5 in CN 103666201A.

### Comparative Example 2

A coating of oil tube was prepared according to the method as described in Example 1 in CN101074338B.

### Comparative Example 3

A corrosion resistant coating was prepared in substantially the same way as in Example 6, but with the difference that the vinyl-modified fluorocarbon resin was replaced by polytetrafluoroethylene resin.

### Test Examples

The component A in Examples 4-6 was mixed with the isocyanate in a weight ratio of 100:2. To the mixture, deionized water was added so as to adjust the viscosity thereof to 20 to 30 S (measured by a T-4 cup). These resulting coatings were each sprayed onto a board. The boards were allowed to dry. Performances of the coatings on the dried boards were measured, and the results are shown in Table 2.

The dried boards were placed into an incubator at 25° C. to cure for 7 days. Resistances to water, acids, bases, and weathering, of the coating films formed on the dried boards were evaluated, and the results are shown in Table 2.

TABLE 2
Evaluation of performances of the coatings prepared in Examples 4-6 and in Comparative Examples 1-3

| | Technical | | | | | | | Test |
|---|---|---|---|---|---|---|---|---|
| Items | Index | Ex. 4 | Ex. 5 | Ex. 6 | Comp. Ex. 1 | Comp. Ex. 2 | Comp. Ex. 3 | Standard |
| Fineness/μm | ≤30 | 25 | 25 | 25 | 45 | 30 | 35 | GB/T6753.1 |
| Surface dry/h | ≤2 | 0.5 | 0.5 | 05 | 0.5 | 1 | 1 | GB/T1728 |
| Hard dry/h | ≤24 | 12 | 18 | 24 | 18 | 24 | 24 | GB/T1728 |
| Thickness/μm | 80-100 | 96 | 88 | 82 | 120 | 115 | 95 | GB/T13452.2 |
| Bending | ≤2 | 1 | 1 | 1 | 1 | 1 | 1 | GB/T6742 |
| property/mm | | | | | | | | |
| Impact | ≥50 | 50 | 50 | 50 | 50 | 50 | 50 | GB/T1732 |
| resistance/cm | | | | | | | | |
| Cross-cut | ≤1 | 1 | 1 | 1 | 1 | 1 | 1 | GB/T9286 |
| test/Class | | | | | | | | |
| Gloss (60°)/% | ≥50 | 72 | 85 | 92.5 | 30 | 55 | 38 | GB/T9754 |
| CHUNG HWA ® | ≥H | H | H | H | 2H | H | 2H | GB/T6739 |
| pencil hardness | | | | | | | | |
| Water | No change | No change in the | | | Substantially | Substantially | Substantially | GB/T1733 |
| resistance | in the | coating film during | | | no change in | no change | no change in | |
| | coating film | 720 h: no foaming, | | | the coating | in the | the coating | |
| | during 72 h | no variation in gloss, | | | film during | coating film | film during | |
| | | no detachment, and | | | 240 h | during 144 h | 480 h | |
| | | no cracking; | | | | | | |
| | | Adhesion level: Class 1 | | | | | | |
| Strong acid | Substantially | No change after | | | no foaming | No change | no foaming | GB/T9274 |
| resistance/d | no change | immersion in 25.9% | | | after | after | after | |
| | in the | HF and 12% HCl at | | | immersion in | immersion | immersion | |
| | coating film | normal temperature | | | 5% H₂SO₄ at | in 25.9% HF | in 5% | |
| | during 30 d | for 2000 h; | | | normal | and 12% | H₂SO₄ at | |
| | | no foaming after | | | temperature | HCl at | normal | |
| | | immersion in 5% | | | for 1320 h | normal | temperature | |
| | | H₂SO₄ at normal | | | | temperature | for 1000 h | |
| | | temperature for 4000 h | | | | for 800 h; | | |
| Strong base | Substantially | No change in the | | | No foaming | No change | No foaming | GB/T9274 |
| resistance/d | no change | coating film after | | | after | in the | after | |
| | in the | immersion in a base | | | immersion in | coating film | immersion | |
| | coating film | with a pH 12.5 at | | | 5% NaOH at | after | in 5% NaOH | |
| | during 30 d | 150° C. under 70 MPa | | | normal | immersion | at normal | |
| | | for 72 h; | | | temperature | in a base | temperature | |
| | | no foaming after | | | for 1800 h | with a pH | for 1200 h | |
| | | immersion in 5% | | | | 12.5 at 150° C. | | |
| | | NaOH at normal | | | | under 70 | | |
| | | temperature for 4000 h | | | | MPa for 24 h | | |
| QUV/h | 1000 | 1000 h, loss of gloss, | | | Main resin | Main resin | 1000 h, loss | GB/T14522 |
| | h, ≤Class 2 | chalking, and | | | of | of a epoxy | of gloss, | |
| | | discoloration, with | | | solventless | system, and | chalking, | |
| | | each ≤ Class 2 | | | epoxy, and | thus poor | and | |
| | | | | | thus poor | weathering | discoloration, | |
| | | | | | weathering | resistance | with each ≤ | |
| | | | | | resistance | | Class 2 | |
| Salt spray | No foaming, | 2000 | 2000 | 1800 | 1680 | — | 1200 | GB/T1771 |
| resistance/h | no cracking, | | | | | | | |
| | no detachment | | | | | | | |
| | during 800 h | | | | | | | |

The results of Examples 4 to 6 show that the corrosion resistant coating according to the present disclosure was highly resistant to acids, bases, weathering, and salt spray. In particular, each of the coatings in these Examples had a resistance to acids and bases better than that of the coatings in Comparative Examples 1 and 2, and after immersion in different acids and bases at a temperature in the range of 0 to 60° C. for a long period, they were not corroded and exhibited excellent resistances to corrosion and weathering. This indicates that the coating of the present disclosure is adapted to be directly applied onto a surface of a substrate. So, the coating of the present disclosure can be widely used in many fields, such as, petroleum and petrochemical equipments, pipelines, chemical transport vehicles, steel structures of chemical plants, chemical equipments, gas holders, mechanical equipments in coal mines, oceanographic ships, and warships.

The disclosure is described above based on preferable embodiments. It will be apparent to those skilled in the art that various improvements and embellishments can be made without departing from the principle of the invention, and are contemplated to be within the scope of the disclosure.

1-10. (canceled)

11. A method for preparing a vinyl-modified fluorocarbon resin, comprising:
mixing a fluorine-containing vinyl monomer, an initiator, and a tetrafluoroethylene monomer in a gas phase to carry out an addition reaction so as to obtain the vinyl-modified fluorocarbon resin.

12. The method according to claim 11, wherein the addition reaction is carried out at a temperature of 75 to 80° C. for 18 to 22 hours.

13. A corrosion resistant coating, comprising:
a component A and a component B packaged separately;
wherein the component A comprises:
50 to 70 parts by weight of the vinyl-modified fluorocarbon resin prepared by the method of claim 11;
3 to 8 parts by weight of a filler;
2 to 5 parts by weight of zinc phosphate;
2 to 5 parts by weight of a graphene dispersion;
5 to 20 parts by weight of a pigment;
0.2 to 1 parts by weight of a dispersant;
0.1 to 0.3 parts by weight of a defoaming agent;
0.1 to 0.3 parts by weight of a leveling agent;
1 to 3 parts by weight of a polyamide wax dispersion;
0.2 to 0.5 parts by weight of fumed silica; and
9 to 16 parts by weight of an organic solvent;
wherein, the graphene dispersion has a solid content of 2 to 10% by weight, and the polyamide wax dispersion has a solid content of 10 to 20% by weight;
wherein the component B is an isocyanate;
and wherein, the components A and B are adapted to be mixed in use in a weight ratio of 100:10-30.

14. The corrosion resistant coating according to claim 13, wherein the filter is nanoscale barium sulphate having a particle size of 5 to 10 nanometers.

15. The corrosion resistant coating according to claim 13, wherein the organic solvent comprises an aromatic solvent, an ester solvent, a hydrocarbon solvent, a ketone solvent, and an ether solvent in a ratio by volume of 3-4:3-4:1-2:1-2:1-2.

16. A method for preparing the corrosion resistant coating according to claim 13, comprising:
a step of preparing the component A, which comprises:
(1) performing a first mixing to mix the vinyl-modified fluorocarbon resin, the dispersant, the defoaming agent, the polyamide wax dispersion and a portion of the organic solvent so as to obtain a first slurry;
(2) performing a second mixing to mix the first slurry, the pigment, zinc phosphate, the filler, and the fumed silica so as to obtain a second slurry;
(3) performing a third mixing to mix the second slurry and the graphene dispersion so as to obtain a third slurry; and
(4) performing a fourth mixing to mix the third slurry, the leveling agent, and a remainder of the organic solvent so as to obtain the component A;
and, mixing the component A with the component B when in use.

17. The method according to claim 16, wherein the portion of the organic solvent is 50 to 70% by weight of a total weight of the organic solvent.

18. The method according to claim 16, wherein the first mixing is performed under first stirring conditions of a stirring speed of 600 to 800 rpm and a stirring time of 3 to 5 minutes;
wherein the second mixing comprises successively: a second stirring step carried out with a stirring speed of 800 to 1000 rpm for 15 to 20 minutes, and a grinding step; wherein the third slurry has a fineness of 20 to 30 microns;
wherein the third mixing is performed under third stirring conditions of a stirring speed of 1000 to 1200 rpm and a stirring time of 15 to 20 minutes;
and wherein the fourth mixing is performed under fourth stirring conditions of a stirring speed of 800 to 1000 rpm and a stirring time of 5 to 10 minutes.
